(19) United States
(12) Patent Application Publication
(10) Pub. No.: US 2007/0140295 A1
(43) Pub. Date: Jun. 21, 2007

(54) Packet data analysis program, packet data analyzer, and packet data analysis method

(75) Inventor: Naoki Akaboshi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/374,004

(22) Filed: Mar. 14, 2006

(30) Foreign Application Priority Data
Dec. 16, 2005 (JP) 2005-362667

(51) Int. Cl. H04J 3/22; H04J 3/00

(52) U.S. Cl. 370/468; 370/498

(57) ABSTRACT

There is provided a packet data analysis program and a packet data analyzer that analyze packet data captured at a plurality of locations on a network and correct the time at which the packet data is captured. A packet data analysis program allows a computer to execute analysis of packet data. The program allows the computer to execute: a packet data collection step that collects packet data captured at a plurality of locations on the network and a time stamp indicating the time at which the packet data is captured; a message information acquisition step that acquires message information, which is information related to a message, from the packet data collected by the packet data collection step; a time stamp correction step that corrects a difference in the time stamp depending on the location based on the message information acquired by the message information acquisition step.

### BACKGROUND OF THE INVENTION

1. Field of the Invention

The present invention relates to a packet data analysis program, a packet data analyzer, and a packet data analysis method that analyze packet data on a network.

2. Description of the Related Art

It is effective to use packet data collected from a network when accurately analyzing the operating state of a system without reconfiguring services of the system. In the case where the scale of a system is large, packet data must be captured at a plurality of locations. Thus, it is very important to accurately adjust the time between packet data collected at a plurality of locations for accurately grasping a system operating state.

As a prior art related to the present invention, Jpn. Pat. Appln. Laid-Open Publication No. 2004-207962 is known. A communication system disclosed in the above publication captures a packet transmitted thorough a port specified by a router and displays the captured packet data on a console.

However, an NTP (Network Time Protocol) which has been used for time adjustment had a limitation in accuracy in the case where the system scale is large. Further, in the case of a system having a plurality of different networks, it is impossible to acquire packets traveling through the same locations, so that accurate time adjustment could not be performed.

### SUMMARY OF THE INVENTION

The present invention has been made to solve the above problem, and an object thereof is to provide a packet data analysis program, and a packet data analyzer that analyzes packet data captured at a plurality of locations on a network and corrects the time at which the packet data is captured.

To solve the above problem, according to a first aspect of the present invention, there is provided a packet data analysis program allowing a computer to execute analysis of packet data, the program allowing the computer to execute: a packet data collection step that collects packet data captured at a plurality of locations on a network and a time stamp indicating the time at which the packet data is captured; a message information acquisition step that acquires message information, which is information related to a message, from the packet data collected by the packet data collection step; a time stamp correction step that corrects a difference in the time stamp depending on the location based on the message information acquired by the message information acquisition step.

Further, in the packet data analysis program according to the present invention, the message information includes any of the type of processing, direction of the message indicating whether a message is a request message or response message, or parameters related to the processing.

Further, in the packet data analysis program according to the present invention, each of the plurality of locations on the network is a mirror port of a switch provided on the network.

Further, in the packet data analysis program according to the present invention, the time stamp correction step divides the network into layers and corrects a difference in the time stamp between adjacent layers to thereby correct differences in time stamps in all the layers.

Further, the packet data analysis program according to the present invention further allows the computer to execute: a transaction model generation step that estimates a transaction and the time difference between messages based on the message information acquired by the message information acquisition step and the time stamp corrected by the time stamp correction step and generates a transaction model from the estimation result; and a time stamp recorrection step that recorrects the time stamp corrected by the time stamp correction step based on the transaction model generated by the transaction model generation step.

Further, in the packet data analysis program according to the present invention, the transaction model generation step recognizes respective processing corresponding to the processing types based on the correspondence between request and response messages for each processing type, selects a message group according to selection criteria which is based on the certainty of the invocation relation between processing operations, and generates a transaction model that satisfies constraint condition related to the invocation relation between processing operations based on the message groups.

Further, in the packet data analysis program according to the present invention, the time stamp recorrection step uses the average value of differences in the time stamps depending on the locations, the average value being obtained from a plurality of transaction models generated by the transaction model generation step, to correct the time stamp corrected by the time stamp correction step.

Further, in the packet data analysis program according to the present invention, the time stamp recorrection step uses transaction models selected, by an instruction from a user, from a plurality of transaction models generated by the transaction model generation step to calculate the average value.

Further, in the packet data analysis program according to the present invention, the constraint condition defines that the processing time period of an invocation source contains the processing time period of an invocation destination.

Further, in the packet data analysis program according to the present invention, the constraint condition defines the invocation direction between nodes.

Further, in the packet data analysis program according to the present invention, the transaction model generation step calculates the time required for the processing corresponding to respective processing types to be performed in each node based on the time length between a request message and its corresponding response message for each processing type in the same transaction and sets the calculated time in the transaction model.

Further, in the packet data analysis program according to the present invention, the transaction model generation step determines the processing time period of each transaction from a request message that is invoked by a client first and a response message corresponding to the request message, detects non-multiplexed transaction in which processing time period of one transaction does not overlap that of another transaction, and determines the invocation relation between processing operations within the processing time period of the detected non-multiplexed transaction.

Further, in the packet data analysis program according to the present invention, in the case where there are a plurality of processing that can be invoked for the invocation destination processing, the transaction model generation step defines invocation probability from the respective processing evenly and integrates the probabilities of invocation from the invocation source processing to another processing for each processing type to thereby calculate the possibility in the invocation relation between processing operations.

Further, in the packet data analysis program according to the present invention, the transaction model generation step generates, for each processing type, one or more generation patterns each indicating a combination of the processing operations that can be invoked, calculates occurrence probability for each generation pattern, selects a predetermined number of generation patterns having a higher occurrence probability and generates a transaction model based on the selected generation patterns.

According to a second aspect of the present invention, there is provided a packet data analyzer that analyzes packet data, comprising: a packet data collection section that collects packet data captured at a plurality of locations on a network and a time stamp indicating the time at which the packet data is captured; a message information acquisition section that acquires message information, which is information related to a message, from the packet data collected by the packet data collection section; a time stamp correction section that corrects a difference in the time stamp depending on the location based on the message information acquired by the message information acquisition section.

Further, in the packet data analyzer according to the present invention, the message information includes any of the type of processing, direction of the message indicating whether a message is a request message or response message, or parameters related to the processing.

Further, in the packet data analyzer according to the present invention, each of the plurality of locations on a network is a mirror port of a switch provided on the network.

Further, in the packet data analyzer according to the present invention, the time stamp correction section divides the network into layers and corrects a difference in the time stamp between adjacent layers to thereby correct differences in time stamps in all the layers.

Further, the packet data analyzer according to the present invention further comprises: a transaction model generation section that estimates a transaction and the time difference between messages based on the message information acquired by the message information acquisition section and the time stamp corrected by the time stamp correction section and generates a transaction model from the estimation result; and a time stamp recorrection section that recorrects the time stamp corrected by the time stamp correction section based on the transaction model generated by the transaction model generation section.

According to a third aspect of the present invention, there is provided a packet data analysis method that analyzes packet data, comprising: a packet data collection step that collects packet data captured at a plurality of locations on a network and a time stamp indicating the time at which the packet data is captured; a message information acquisition step that acquires message information, which is information related to a message, from the packet data collected by the packet data collection step; a time stamp correction step that corrects a difference in the time stamp depending on the location based on the message information acquired by the message information acquisition step.

According to the present invention, by collecting packet data captured at a plurality of locations on a network and analyzing them, the time at which the packet data has been captured can be corrected.

### BRIEF DESCRIPTION OF THE DRAWINGS

FIG. 1 is a block diagram showing a configuration example of a Web system according to an embodiment of the present invention;

FIG. 2 is a block diagram showing a first connection relation in the Web system according to the embodiment;

FIG. 3 is a block diagram showing a configuration example of a packet data analyzer according to the embodiment;

FIG. 4 is a flowchart showing an example of operation of a time stamp correction section according to the embodiment;

FIG. 5 is a sequence diagram showing an operation example of a first time difference calculation processing according to the embodiment;

FIG. 6 is a block diagram showing a second connection relation in the Web system according to the embodiment;

FIG. 7 is a block diagram showing a second connection relation in which nodes of the Web system according to the embodiment are partly aggregated; and

FIG. 8 is a sequence diagram showing an operation example of the time stamp correction section in a large-scale Web system.

### DETAILED DESCRIPTION OF THE PREFERRED EMBODIMENTS

An embodiment of the present invention will be described below with reference to the accompanying drawings.

The following description will be given taking a Web system using a packet data analyzer according to the present invention as an example.

Firstly, a configuration of the Web system according to the embodiment will be described.

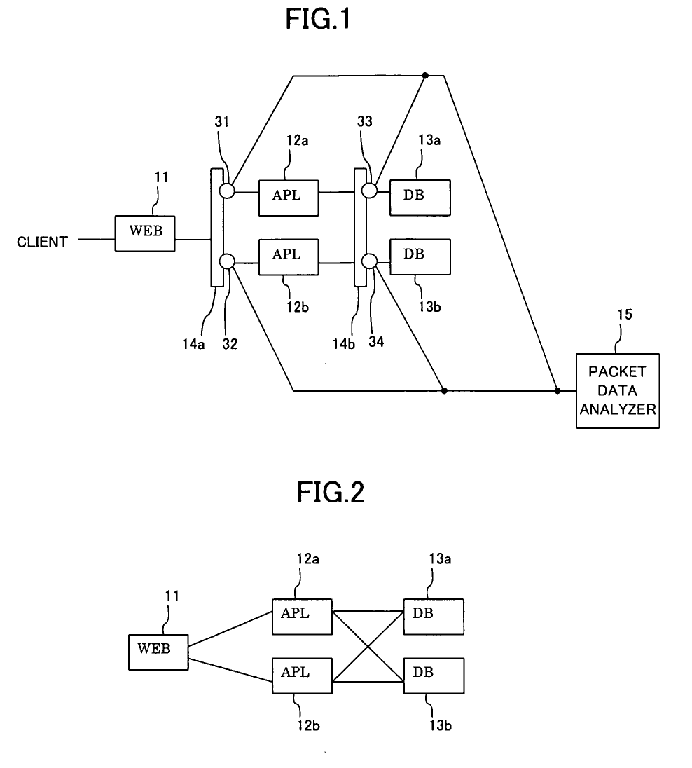

FIG. 1 is a block diagram showing a configuration example of the Web system according to the embodiment of the present invention. The Web system includes a Web server (WEB) 11, application servers (APL) 12a and 12b, databases (DB) 13a and 13b, load distributors 14a and 14b, and a packet data analyzer 15. An access from the WEB 11 to the APLs 12a, 12b is load-distributed by the load distributor 14a. Accesses from the APLs 12a, 12b to the DBs 13a, 13b are load-distributed by the load distributor 14b. The load distributors 14a, 14b are connected to the packet data analyzer 15 through paths different from those connected to the APLs 12a, 12b and DBs 13a, 13b. The Web system according to the embodiment is divided into three layers, as shown in FIG. 1: Web server layer, application server layer, and database layer.

Four packet capture points are set in the Web system: packet capture point (C) 31 set in the load distributor 14a at the portion between itself and APL 12a, packet capture point (C) 32 set in the load distributor 14a at the portion between itself and APL 12b, packet capture point (C) 33 set in the load distributor 14b at the portion between itself and DB 13a, and packet capture point (C) 34 set in the load distributor 14b at the portion between itself and DB 13b. It is assumed that the same packet does not travel through capture points C31, C32, C33, and C34. The capture point is realized, for example, by a mirror port of a switch. Packet data captured at the capture point and time stamp indicating the time at which the packet data is captured are transmitted to the packet data analyzer 15.

Logical connection relation in the Web system will next be described.

FIG. 2 is a block diagram showing a first connection relation in the Web system according to the embodiment. Hereinafter, the first connection relation is used to describe operation of the Web system. The following four channels are logically established in the first connection relation.

1. WEB 11→APL 12a→DB 13a

2. WEB 11→APL 12a→DB 13b

3. WEB 11→APL 12b→DB 13a

4. WEB 11→APL 12b→DB 13b

A configuration of the packet data analyzer according to the embodiment will next be described.

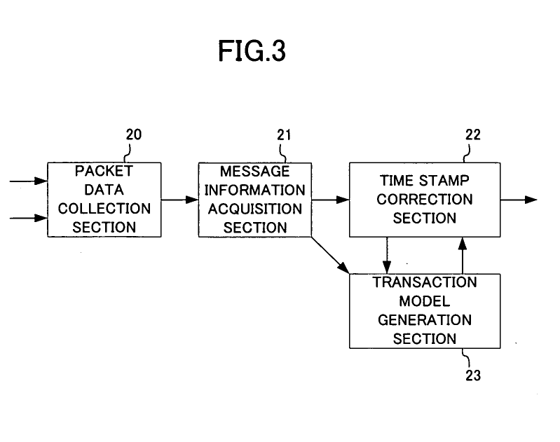

FIG. 3 is a block diagram showing a configuration example of the packet data analyzer according to the embodiment. The packet data analyzer 15 includes a packet data collection section 20, a message information acquisition section 21, a time stamp correction section 22, and a transaction model generation section 23. The packet data collection section 20 collects packet data and time stamps transmitted from the respective capture points.

Operation of the message information acquisition section 21 will next be described.

The message information acquisition section 21 analyzes the packet data collected by the packet data collection section 20 and acquires the message information of the upper layer, such as HTTP, included in the packet data. The message information includes the type of processing requested in the message, direction of the message (request message or response message), and parameters in the request message. In the case where HTTP (HyperText Transfer Protocol) is applied to the message, the type of processing can be determined by URL (Uniform Resource Locator) specified in a processing request. An example of CGI parameter in an HTTP request captured at capture point C31 is shown below.

http://www.test.com/login.html?userID=01223&item=TOP

In the above parameter, user ID and item are inserted after symbols “?” and “&”, respectively and their values are embedded after “=”, respectively. Similar parameters are embedded in IIOP (Internet Inter-ORB Protocol) in communications between the WEB 11 and APLs 12a, 12b. In the embodiment of the present invention, it is assumed that the same parameter as in HTTP, “userID=01223”, is embedded. In this case, packet data is captured by the same clock between the WEB 11 and respective APLs 12a, 12b, so that it is possible to make association between invocations using userID.

In a SQL (Structured Query Language) sentence captured at capture point C33, parameter “userID=01223” is specified as follows, according to ANSI SQL standard.

SELECT amount from userData where userID=01223

A first time stamp correction processing performed by the time stamp correction section 22 will next be described.

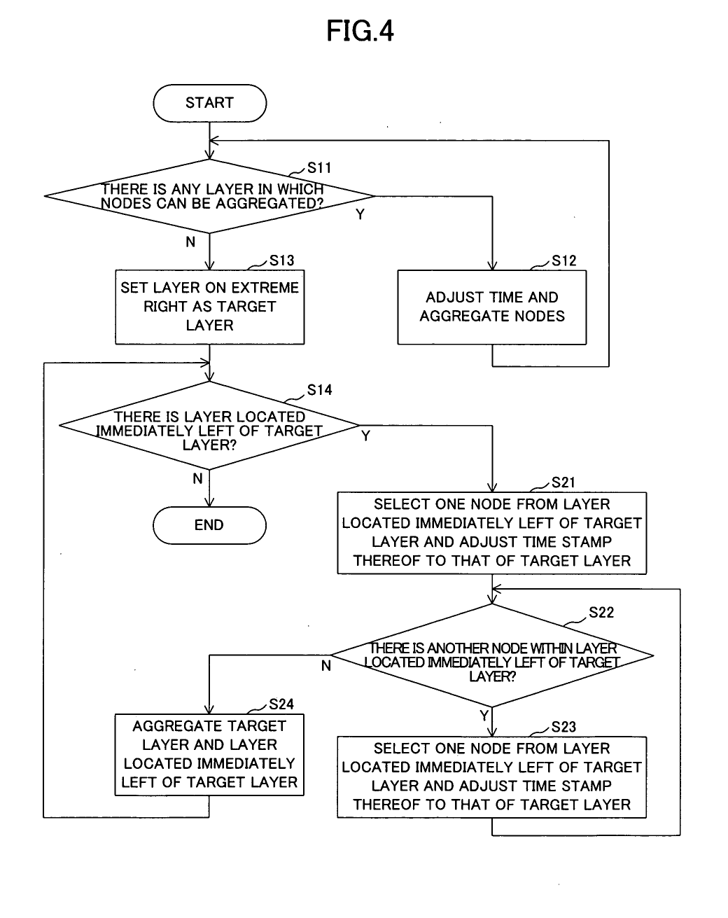

The time stamp correction section 22 uses the message information acquired by the message information acquisition section 21 to correct the time stamp collected by the packet data collection section 20, as a first time stamp correction processing. The following description is made according to the arrangement of the Web system shown in FIG. 1, where the layer closed to a client is defined as a left-side layer and layer away from the client is defined as a right-side layer. FIG. 4 is a flowchart showing an example of operation of the time stamp correction section 22 according to the embodiment. The time stamp correction section 22 firstly determines whether there is any layer in which nodes can be aggregated together (S11). When determining that there is any layer in which nodes can be aggregated (Y in S11), the time stamp correction section 22 aggregates nodes within the same layer, that is, adjusts the time stamps of the nodes within the same layer, merges packet data of the nodes within the same layer (S12), and shifts to step S11, where the time stamp correction section 22 determines another layer. On the other hand, when determining that there is no layer in which nodes can be aggregated (N in S11), the time stamp correction section 22 sets a layer on the extreme right in the Web system as a target layer of the time stamp correction (S13).

Then the time stamp correction section 22 determines whether there is a layer located immediately left of the target layer (S14). When determining that there is no layer located immediately left of the target layer (N in S14), the time stamp correction section 22 ends this flow. On the other hand, when determining that there is a layer located immediately left of the target layer (Y in S14), the time stamp correction section 22 selects one node from the layer located immediately left of the target layer and adjusts the time stamp of the node within the target layer to the time stamp of the selected node (S21).

The time stamp correction section 22 then determines whether there is another node within the layer located immediately left of the target layer (S22). When determining that there is no other node (N in S22), the time stamp correction section 22 aggregates the target layer and the layer located immediately left of the target layer, that is, merges packet data of the target layer and layer located immediately left of the target layer (S24) and shits to step S14. On the other hand, when determining that there is another node (Y in S22), the time stamp correction section 22 selects the another node within the layer located immediately left of the target layer and adjusts the time stamp of the selected node to the time stamp of the node within the target layer (S23) and shifts to step S22.

Next, a first time difference calculation processing for calculating the time difference between two nodes in above steps S21 and S23 will be described.

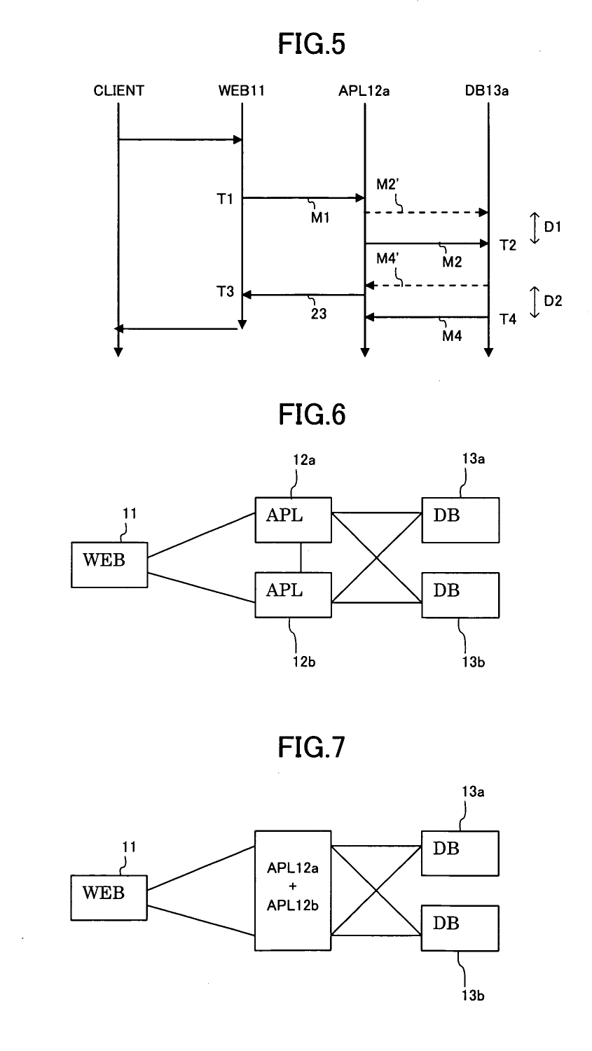

In the first time difference calculation processing, the time stamp correction section 22 uses message information acquired by the message information acquisition section 21 to correct the time stamp. FIG. 5 is a sequence diagram showing an operation example of the first time difference calculation processing according to the embodiment. In this example, request M1 from the WEB 11 to APL 12a, request M2 from the APL 12a to DB 13a, reply M4 from the DB 13a to APL 12a, and reply M3 from the APL 12a to WEB 11 are collected by the packet data collection section 20 as packet data. M2′ and M4′ denoted by dotted lines are obtained by correcting the time stamps of M2 and M4, respectively. Since there is a time difference in the time stamps of M2 and M4, the order of packet data M3 and M4 is reversed.

The time stamp correction section 22 recognizes M1 and M2 as a pair of packet data having “userID=01234” based on the message information. Accordingly, it is possible to obtain a constraint condition T1<T2, where T1 is the time stamp of M1 and T2 is the time stamp of M2. Similarly, it is possible to obtain a constraint condition T4<T3, where T4 is the time stamp of M4 and T3 is the time stamp of M3. Then the time stamp correction section 22 corrects T2 and T4 such that they are located between T1 and T3. More concretely, the time stamp correction section 22 corrects the time stamps such that time difference D1 (=T2−T1) becomes equal to time difference D2 (=T3−T4). The time stamp correction section 22 recognizes the time difference as the time difference between the APL 12a and DB 13a and sets α1 as its value. The time difference between the APL 12a and DB 13b, which is obtained in the similar manner as for α1, is defined as β1.

The time stamp correction section 22 sets the layer that the DBs 13a, 13b belong to as a target layer in step S13 and selects the APL 12a which is one of the nodes within a layer located immediately left of the target layer in step S21, and adjusts the time stamps of the DBs 13a, 13b which are nodes within the target layer relative to the time stamp of the APL 12a. This corrects the time stamp of the DB 13a by α1 relative to the APL 12a and time stamp of the DB 13b by P1 relative to the APL 12a. As a result, the times of the APL 12a, DB 13a, and DB 13b, i.e., the time stamps of C31, C33, and C34 are adjusted.

The time stamp correction section 22 selects the APL 12b which is another node within the layer immediately left of the target layer and adjusts the time stamp of the APL 12b relative to the time stamp of the DBs 13a and 13b which are nodes within the target layer, in step S23. The time difference between the APL 12b and DB 13b and that between the APL 12b and DB 13b, which are obtained in the similar manner as for α1 and β1, are defined as α2 and β2, respectively. The time stamp correction section 22 then corrects the time stamp of the APL 12b by [average value−(α2+β2)/2] in order to adjust the time of the APL 12b relative to APL 12a. As a result, all the times of APL 12a, APL 12b, DB 13a, and DB 13b, i.e., all the time stamps of C31, C32, C33, and C34 are adjusted.

According to the first time difference calculation processing, it is possible to estimate the time difference between nodes based on the message information.

Next, the first time stamp correction processing performed in the case where an invocation relation occurs within the same layer in the logical connection relation in the Web system will be described.

FIG. 6 is a block diagram showing a second connection relation in the Web system according to the embodiment. The following four channels are logically established in the second connection relation.

1. WEB 11→APL 12a→APL 12b→DB 13a

2. WEB 11→APL 12a→DB 13b

3. WEB 11→APL 12b→APL 12a DB 13a

4. WEB 11→APL 12b→DB 13b

In the case where the APL 12a and APL 12b which belong to the same layer communicate with each other, the time stamp correction section 22 adjusts the time stamps of the APL 12a and APL 12b and aggregates the nodes. That is, packet data can be merged. Since the APL 12a and APL 12b which belong to the same layer can use an identical packet, the time stamps are adjusted using the identical packet. As a result, APL 12a and APL 12b are treated as one node. FIG. 7 is a block diagram showing the second connection relation in which nodes of the Web system according to the embodiment are partly aggregated. Thereafter, the time stamp correction section 22 performs step S13 and subsequent time stamp correction processing steps.

Next, operation of the time stamp correction section in a large-scale system will be described.

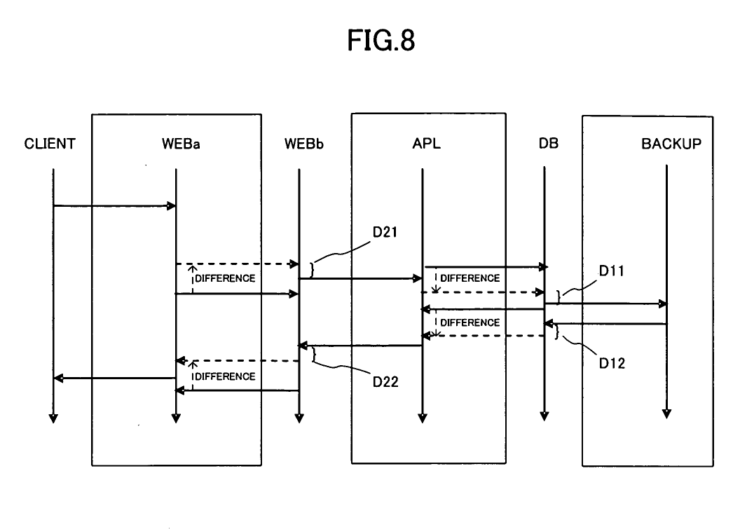

FIG. 8 is a sequence diagram showing an operation example of the time stamp correction section in a large-scale Web system. This Web system includes a client, a WEB (Web server) a, a WEB (Web server) b, an APL (application server), a DB (database), and a BUCKUP (backup server), each of which is recognized as a layer. The abovementioned first time stamp correction processing is performed with the BUCKUP, which is a layer located on the extreme right, set as a target layer and, successively, the time stamp correction and node aggregation are performed for residual layers on the left side of the target layer. In the example of FIG. 8, firstly, the time difference in the APL and DB is corrected such that message time differences D11 and D12 become equal to each other and then the time difference in the WEB a and WEB b is corrected such that the message time difference D21 and D22 become equal to each other.

According to the above first time stamp correction processing, it is possible to estimate the time difference between nodes, correct the time stamp, and correct the order of messages, even in a large scale system.

Next, operation of the transaction model generation section 23 will be described.

The transaction model generation section 23 uses message information acquired by the message information acquisition section 21 and the time stamp corrected by the time stamp correction section 22 to generate a transaction model including a transaction and the time of messages in the transaction. Further, the transaction model generation section 23 generates a plurality of transaction models having different processing times.

Firstly, the transaction model generation section 23 recognizes respective processing corresponding to the processing types based on the correspondence between request and response messages for each processing type in the message information. Then, the transaction model generation section 23 selects messages according to selection criteria which is based on the certainty of the invocation relation between processing and treats them as a message group. The transaction model generation section 23 generates a transaction model such that the message group satisfies constraint condition related to the invocation relation between processing. Further, the transaction model generation section 23 calculates the time required for the processing corresponding to respective processing types to be performed in each node based on the time length between a request message and its corresponding response message for each processing type in the same transaction and sets the calculated time in the transaction model.

An example of the selection criteria includes, for example, selecting the message group from the time period of non-multiplexed transaction in which processing time period of one transaction does not overlap that of another transaction. That is, only a portion in which each transaction does not overlap another transaction (from a request from a client to corresponding response to the client) is extracted to obtain a model. The transaction model generation section 23 determines that the certainty of existence of an invocation relation between respective processing operations in the processing time period during which the non-multiplexed transaction is executed is high.

The transaction model generation section 23 firstly detects pairs of request and response which are sent using a HTTP protocol and which have the same identification number. Then, the transaction model generation section 23 checks whether there exists a HTTP message having a different identification number between the message pair of HTTP protocol. When determining that there is no such HTTP message, the transaction model generation section 23 selects the pair of request/response of HTTP protocol and requests between them. That is, a transaction that is not in cross-cutting relationship with another is extracted.

As describe above, the transaction model generation section 23 specifies messages constituting the transaction that does not overlap another transaction and selects massages for model generation.

An example of the constraint condition includes, for example, a condition that the processing time period of an invocation source contains the processing time period of an invocation destination. That is, the start time of processing invoked by given processing is after the processing start time of the invocation source, and the end time thereof is before the processing end time of the invocation source. Besides, the constraint condition defines invocation direction between nodes. In addition, the constraint condition defines that the processing of IIOP is directly invoked by a device outside the system (e.g., client) or that the processing of the DB is invoked by the IIOP without exception.

In the case where there are a plurality of processing that can be invoked for the invocation destination processing, the transaction model generation section 23 uses such invocation conditions to define invocation probability from the respective processing evenly, and integrates the probabilities of invocation from the invocation source processing to another processing for each processing type to thereby calculate the possibility in the invocation relation between processing operations. As a result, it is possible to generate a transaction model even in the case where a plurality of transactions are processed at the same time.

Further, the transaction model generation section 23 generates, for each processing type, one or more generation patterns each indicating a combination of the processing operations that can be invoked and calculates occurrence probability for each generation pattern. The transaction model generation section 23 then selects a predetermined number of generation patterns having a higher occurrence probability and generates a transaction model based on the selected generation patterns. As a result, even in the case where there are a plurality of processing patterns that can be used for the processing type of a given invocation source, it is possible to correctly generate a model of the transaction.

As described above, the transaction model generation section 23 can extract an invocation relation clearly specified in the message information as well as extract an invocation relation that is not clearly specified in the message information.

Next, a second time stamp correction processing performed by the time stamp correction section 22 will be described.

The time stamp correction section 22 uses a plurality of transaction models generated by the transaction model generation section 23 to perform more accurate time stamp correction as a second time stamp correction processing. The second time stamp correction processing is performed in the same manner as the first time stamp correction processing. A different point from the first time stamp correction processing is that a second time difference correction processing is performed in place of the first time difference correction processing.

The second time difference calculation processing for calculating the time difference between two nodes in the above steps S21 and S23 will next be described.

A plurality of transaction models in which the time difference between nodes differs from each other are generated by the transaction model generation section 23. It is assumed that the transaction model generation section 23 generates, in the same sequence as shown in FIG. 5, model A (time difference between WEB 11 and APL 12a is 65 msec), model B (time difference between WEB 11 and APL 12a is 55 msec), and model C (time difference between WEB 11 and APL 12a is 75 msec) as a transaction model.

While a plurality of the transaction models in which the time difference between nodes differs from each other are generated, 65 msec, which is the average value between the time difference values of all the models, is determined as the time difference between the WEB 11 and APL 12a since, in fact, there is only one value defined for the time difference. Although all the models are used for the calculation here, models to be used for the calculation may be selected by a user. In this case, only the selected models are used to obtain the average value.

The time stamp correction section 22 uses the second time difference correction processing to perform correction of the time stamp in the same manner as the first time stamp correction processing. The packet data merged and time stamp corrected by the time stamp correction section 22 are used for analysis of system operating state and the like.

According to the abovementioned second time difference calculation processing, it is possible to detect the time difference from an invocation relation that is not clearly specified in the message information. Further, by using the transaction model, it is possible to calculate the time difference with high accuracy. Further, according to the second time stamp correction processing, it is possible to perform correction of the time stamp more accurately than when using the first time stamp correction processing.

The packet data analyzer according to the embodiment can easily be applied to a network monitoring apparatus and can enhance the capability thereof. When the network monitoring apparatus and the like monitors the packet data whose time stamp has been corrected, they can analyze a system operating state more accurately.

Further, it is possible to provide a program that allows a computer constituting the packet data analyzer to execute the above steps as a packet data analysis program. By storing the above program in a computer-readable storage medium, it is possible to allow the computer constituting the packet data analyzer to execute the program. The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

What is claimed is:

1. A packet data analysis program allowing a computer to execute analysis of packet data, the program allowing the computer to execute:
a packet data collection step that collects packet data captured at a plurality of locations on a network and a time stamp indicating the time at which the packet data has been captured;
a message information acquisition step that acquires message information, which is information related to a message, from the packet data collected by the packet data collection step;
a time stamp correction step that corrects a difference in the time stamp depending on the location based on the message information acquired by the message information acquisition step.

2. The packet data analysis program according to claim 1, wherein
the message information includes any of the type of processing, direction of the message indicating whether a message is a request message or response message, or parameters related to the processing.

3. The packet data analysis program according to claim 1, wherein
each of the plurality of locations on the network is a mirror port of a switch provided on the network.

4. The packet data analysis program according to claim 1, wherein
the time stamp correction step divides the network into layers and corrects a difference in the time stamp between adjacent layers to thereby correct differences in time stamps in all the layers.

5. The packet data analysis program according to claim 2, further allowing the computer to execute:
a transaction model generation step that estimates a transaction and the time difference between messages based on the message information acquired by the message information acquisition step and the time stamp corrected by the time stamp correction step and generates a transaction model from the estimation result; and
a time stamp recorrection step that recorrects the time stamp corrected by the time stamp correction step based on the transaction model generated by the transaction model generation step.

6. The packet data analysis program according to claim 5, wherein
the transaction model generation step recognizes respective processing corresponding to the processing types based on the correspondence between request and response messages for each processing type, selects a message group according to selection criteria which is based on the certainty of the invocation relation between processing operations, and generates a transaction model that satisfies constraint condition related to the invocation relation between processing operations based on the message groups.

7. The packet data analysis program according to claim 5, wherein
the time stamp recorrection step uses the average value of differences in the time stamps depending on the locations, the average value being obtained from a plurality of transaction models generated by the transaction model generation step, to correct the time stamp corrected by the time stamp correction step.

8. The packet data analysis program according to claim 7, wherein
the time stamp recorrection step uses transaction models selected, by an instruction from a user, from a plurality of transaction models generated by the transaction model generation step to calculate the average value.

9. The packet data analysis program according to claim 5, wherein
the constraint condition defines that the processing time period of an invocation source contains the processing time period of an invocation destination.

10. The packet data analysis program according to claim 5, wherein
the constraint condition defines the invocation direction between nodes.

11. The packet data analysis program according to claim 5, wherein
the transaction model generation step calculates the time required for the processing corresponding to respective processing types to be performed in each node based on the time length between a request message and its corresponding response message for each processing type in the same transaction and sets the calculated time in the transaction model.

12. The packet data analysis program according to claim 5, wherein
the transaction model generation step determines the processing time period of each transaction from a request message that is invoked by a client first and a response message corresponding to the request message, detects non-multiplexed transaction in which processing time period of one transaction does not overlap that of another transaction, and determines the invocation relation between processing operations within the processing time period of the detected non-multiplexed transaction.

13. The packet data analysis program according to claim 5, wherein
in the case where there are a plurality of processing that can be invoked for the invocation destination processing, the transaction model generation step defines invocation probability from the respective processing evenly and integrates the probabilities of invocation from the invocation source processing to another processing for each processing type to thereby calculate the possibility in the invocation relation between processing operations.

14. The packet data analysis program according to claim 5, wherein
the transaction model generation step generates, for each processing type, one or more generation patterns each indicating a combination of the processing operations that can be invoked, calculates occurrence probability for each generation pattern, selects a predetermined number of generation patterns having a higher occurrence probability and generates a transaction model based on the selected generation patterns.

15. A packet data analyzer that analyzes packet data, comprising:
a packet data collection section that collects packet data captured at a plurality of locations on a network and a time stamp indicating the time at which the packet data is captured;
a message information acquisition section that acquires message information, which is information related to a message, from the packet data collected by the packet data collection section;
a time stamp correction section that corrects a difference in the time stamp depending on the location based on the message information acquired by the message information acquisition section.

16. The packet data analyzer according to claim 15, wherein
the message information includes any of the type of processing, direction of the message indicating whether a message is a request message or response message, or parameters related to the processing.

17. The packet data analyzer according to claim 15, wherein
each of the plurality of locations on the network is a mirror port of a switch provided on the network.

18. The packet data analyzer according to claim 15, wherein
the time stamp correction section divides the network into layers and corrects a difference in the time stamp between adjacent layers to thereby correct differences in time stamps in all the layers.

19. The packet data analyzer according to claim 15, further comprising:
a transaction model generation section that estimates a transaction and the time difference between messages based on the message information acquired by the message information acquisition section and the time stamp corrected by the time stamp correction section and generates a transaction model from the estimation result; and
a time stamp recorrection section that recorrects the time stamp corrected by the time stamp correction section based on the transaction model generated by the transaction model generation section.

20. A packet data analysis method that analyzes packet data, comprising:
a packet data collection step that collects packet data captured at a plurality of locations on a network and a time stamp indicating the time at which the packet data is captured;
a message information acquisition step that acquires message information, which is information related to a message, from the packet data collected by the packet data collection step;
a time stamp correction step that corrects a difference in the time stamp depending on the location based on the message information acquired by the message information acquisition step.
